(19) United States
(12) Patent Application Publication
(10) Pub. No.: US 2005/0076072 A1
(43) Pub. Date: Apr. 7, 2005

(54) Symbol points estimating device, method and program, recording medium on which the program is recorded, and modulation analyzing device

(76) Inventor: Masahiko Muto, Saitama (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/468,235

(22) PCT Filed: Jan. 21, 2002
(86) PCT No.: PCT/JP02/00380

(30) Foreign Application Priority Data
Feb. 20, 2001 (JP) 2001-42983

(51) Int. Cl. G06F 17/10

(52) U.S. Cl. 708/300

(57) ABSTRACT

FFT units (22a, 22b) of signal correlation calculating means (22) converts a clock delay corrected signal (a signal the symbolic point of which is corrected roughly) and a reference signal serving as a reference of modulation into signals of corresponding frequencies. A multiplier (22c) multiplies those signals of corresponding frequencies. An inverse FFT unit (22e) returns the result of the multiplication to a time corresponding signal. As a result, the correlation between the measured signal and the reference signal is calculated so that the position of the symbol point is calculated from the result of the calculation by a symbol point calculating unit (28). Therefore, the symbol point can be accurately estimated.

### TECHNICAL FIELD

The present invention relates to measuring a symbol point of a modulation method such as QPSK (Quadrature Phase Shift Keying) modulation.

### BACKGROUND ART

It is important to precisely obtain the position of a symbol point for modulation analysis in different types of modulation methods such as QPSK used for radio communication and the like. The reason is that the precision of the modulation analysis decreases unless the position of the symbol point is precisely obtained. Thus, it is necessary to precisely estimate the position of the symbol point.

The following section describes Clock Delay method which is a conventional method for estimating a symbol point. The Clock Delay method is a method for extracting a clock of the symbol rate. The description here is provided for an example of using the Clock Delay method in W-CDMA (Wide band Code Division Multiple Access). First, FIG. 9 shows a spectrum of a received signal of the W-CDMA. The received signal of W-CDMA hardly includes a symbol rate (3.84 Msps) component. Thus, it is difficult to extract the clock directly from the symbol rate (3.84 Msps) component. However, a large quantity of a 1.92 MHz component is included in the received signal.

Thus, a signal of 3.84 MHz is generated by multiplication using the component of half a frequency (1.92 Msps=1.92 MHz) of the symbol rate (3.84 Msps). Then, the symbol point is estimated by obtaining the phase of the generated signal of 3.84 MHz. The phase of the generated signal of 3.84 MHz is obtained according to expression (1).

$$arctan \{ \frac{{\sum }_{k = 0}^{n} [ {I}_{k}^{2} + {Q}_{k}^{2} ] \cdot sin [ 2 π {f}_{symbol} \cdot \frac{k}{{f}_{sample}} ]}{{\sum }_{k = 0}^{n} [ {I}_{k}^{2} + {Q}_{k}^{2} ] \cdot cos [ 2 π {f}_{symbol} \cdot \frac{k}{{f}_{sample}} ]} \} \qquad ( 1 )$$

Note that fsymbol represents the symbol rate (3.84 Msps), and fsample represents the sample rate. When expression (1) is used to obtain the phase, a transition of the symbol point shown in FIG. 10 is assumed. Namely, it is assumed that the transition moving through point A→point B→point A→ . . . occurs in every symbol period (1/3.84 MHz) for generating the 1.92 MHz component.

However, with the method described above, when the phase characteristic of the 1.92 MHz component is degraded, an error is generated in estimating the symbol point.

In view of the foregoing, the object of the present invention is to provide a symbol point estimating apparatus and the like which precisely estimate a symbol point.

### DISCLOSURE OF THE INVENTION

The present invention as described in claim 1, is a symbol point estimating apparatus for estimating a symbol point of modulation based on a measured signal based on a received signal to which the modulation is applied, and a reference signal serving as a reference of the modulation, the apparatus including: a signal correlation calculating element for calculating correlation between the measured signal and the reference signal; and a symbol point calculating element for calculating a symbol point from a calculated result from the signal correlation calculating element.

With the symbol point estimating apparatus constituted as described above, the signal correlation calculating device calculates the correlation between the measured signal and the reference signal, and then, the symbol point calculating device calculates the position of the symbol point from the result of the correlation calculation. Thus, the symbol point is estimated precisely.

Note that the measured signal is a signal based on the received signal. For example, the measured signal may be a signal whose symbol point is coarsely corrected by applying clock delay correction or the like to the received signal. Alternately, the measured signal may be the received signal itself.

The present invention as described in claim 2, is the symbol point estimating apparatus according to claim 1, wherein the measured signal is a signal generated by correcting the symbol point of the received signal.

The present invention as described in claim 3, is the symbol point estimating apparatus according to claim 1 or 2, wherein the signal correlation calculating element includes: a measured signal transforming element for transforming the measured signal to a frequency-associated measured signal; a reference signal transforming element for transforming the reference signal to a frequency-associated reference signal; a multiplying element for multiplying the frequency-associated measured signal and the frequency-associated reference signal by each other; and a signal inverse-transforming element for transforming an output from the multiplying element to a signal associated with time as a calculated result from the signal correlation calculating element.

The present invention as described in claim 4, is a symbol point estimating apparatus according to claim 3, wherein the signal correlation calculating element further includes a data inserting element for inserting data of a predetermined size to the output from the multiplying element in order to supply the output for the signal inverse-transforming element.

According to the present invention as described in claim 5, the symbol point estimating apparatus according to any one of claims 1 to 4, further includes: an approximating equation calculating element for calculating an approximating equation approximating at least a part of the calculated result by the signal correlation calculating element; and a maximum position calculating element for calculating a position where the approximating equation takes the maximum value based on the approximating equation, and the symbol point calculating element calculates the position of the symbol point based on the position calculated by the maximum position calculating element.

The present invention as described in claim 6, is a modulation analyzing apparatus for analyzing modulation based on a measured signal based on a received signal to which the modulation is applied, and a reference signal serving as a reference of the modulation, the modulation analyzing apparatus including: the symbol point estimating apparatus according to any one of claims 1 to 5; a symbol point correcting element for correcting the measured signal based on the symbol point estimated by the symbol point estimating apparatus, and a modulation analyzing element for using the reference signal and the corrected measured signal to analyze modulation.

Since the measured signal is corrected by the symbol point correcting device based on the symbol point precisely estimated by the symbol point estimating apparatus, the measured signal can be precisely corrected. Then, since the modulation analyzing device uses the reference signal and the precisely corrected measured signal to analyze the modulation, the modulation is analyzed precisely.

The present invention as described in claim 7, is a modulation analyzing apparatus for analyzing modulation based on a measured signal based on a received signal to which the modulation is applied, and a reference signal serving as a reference of the modulation, the modulation analyzing apparatus including: the symbol point estimating apparatus according to any one of claims 1 to 5; a symbol point correcting element for correcting the reference signal based on the symbol point estimated by the symbol point estimating apparatus, and a modulation analyzing element for using the measured signal and the corrected reference signal to analyze modulation.

Since the reference signal is corrected by the symbol point correcting device based on the symbol point precisely estimated by the symbol point estimating apparatus, the reference signal is precisely corrected. Then, since the modulation analyzing device uses the measured signal and the precisely corrected reference signal for the modulation analysis, the modulation is analyzed precisely. Simultaneously, since the reference signal is a signal based on individual symbols, the quantity of the calculation can be reduced in the symbol point correcting device, and the calculation is accelerated.

The present invention as described in claim 8, is a symbol point estimating method for estimating a symbol point of modulation based on a measured signal based on a received signal to which the modulation is applied, and a reference signal serving as a reference of the modulation, the method including: a signal correlation calculating step for calculating correlation between the measured signal and the reference signal; and a symbol point calculating step for calculating a symbol point from a calculated result from the signal correlation calculating step.

The present invention as described in claim 9, is a symbol point estimating method for estimating a symbol point of modulation based on a measured signal based on a received signal to which the modulation is applied, and a reference signal serving as a reference of the modulation, the method including: a signal correlation calculating step for calculating correlation between the measured signal and the reference signal; and a symbol point calculating step for calculating a symbol point from a calculated result from the signal correlation calculating step, wherein the signal correlation calculating step includes: a measured signal transforming step for transforming the measured signal to a frequency-associated measured signal; a reference signal transforming step for transforming the reference signal to a frequency-associated reference signal; a multiplying step for multiplying the frequency-associated measured signal and the frequency-associated reference signal by each other; a signal inverse-transforming step for transforming an output from the multiplying step to a signal associated with time as a calculated result from the signal correlation calculating step; and a data inserting step for inserting data of a predetermined size to the output from the multiplying step in order to supply the output for the signal inverse-transforming step.

The present invention as described in claim 10, is a program of instructions for execution by the computer to perform a symbol point estimating process for estimating a symbol point of modulation based on a measured signal based on a received signal to which the modulation is applied, and a reference signal serving as a reference of the modulation, the process including: a signal correlation calculating processing for calculating correlation between the measured signal and the reference signal; and a symbol point calculating processing for calculating a symbol point from a calculated result from the signal correlation calculating processing.

The present invention as described in claim 11, is a computer-readable medium having a program of instructions for execution by the computer to perform a symbol point estimating process for estimating a symbol point of modulation based on a measured signal based on a received signal to which the modulation is applied, and a reference signal serving as a reference of the modulation, the process including: a signal correlation calculating processing for calculating correlation between the measured signal and the reference signal; and a symbol point calculating processing for calculating a symbol point from a calculated result from the signal correlation calculating processing.

### BRIEF DESCRIPTION OF THE DRAWINGS

FIG. 1 is a block diagram showing the constitution of a modulation analyzing apparatus 1 according to a first embodiment of the present invention;

FIG. 2 shows a reference signal in QPSK modulation;

FIG. 3 is a block diagram showing the internal constitution of a symbol point finely estimating unit 20;

FIG. 4 shows an example of (Y_{f}, 0_{f+xn}) which is Y_{f} after a zero inserting unit 22d inserts zeros;

FIGS. 5(a) and 5(b) show an example of a signal yₜ associated with time, which is a signal formed by applying inverse FFT by an inverse FFT unit 22e, and include an overall view (FIG. 5(a)) and a partially enlarged view (FIG. 5(b));

FIG. 6 shows the absolute value xₜ of the time-associated signal yₜ;

FIG. 7 is a partially enlarged view of the absolute value xₜ of the time-associated signal yₜ;

FIG. 8 is a block diagram showing the constitution of a modulation analyzing apparatus 1 according to a second embodiment of the present invention;

FIG. 9 is a diagram showing a spectrum of a received signal of W-CDMA according to prior art; and

FIG. 10 is a drawing estimating the transition of a symbol point which is assumed in a symbol point estimating method according to prior art.

### BEST MODE FOR CARRYING OUT THE INVENTION

Referring to drawings, the following section describes embodiments of the present invention.

First Embodiment

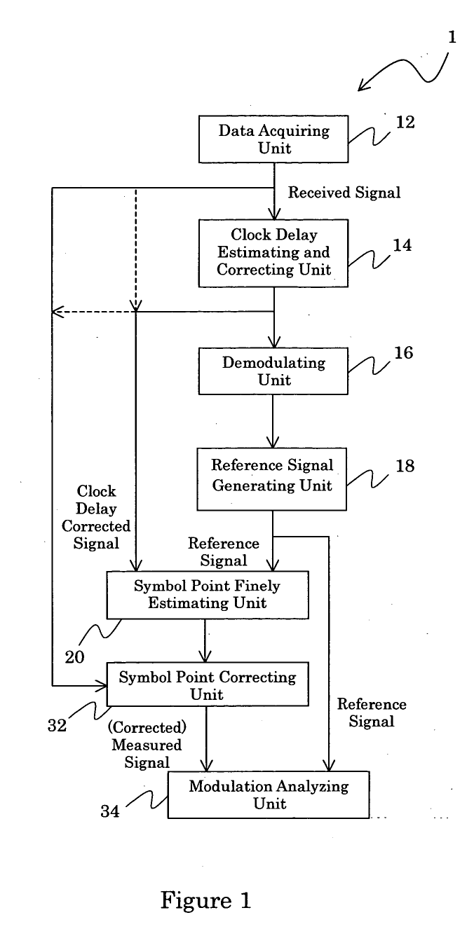

FIG. 1 is a block diagram showing the constitution of a modulation analyzing apparatus 1 according to a first embodiment of the present invention. The modulation analyzing apparatus 1 according to the first embodiment of the present invention includes a data acquiring unit 12, a clock delay estimating and correcting unit 14, a demodulating unit 16, a reference signal generating unit 18, a symbol point finely estimating unit (symbol point estimating apparatus) 20, a symbol point correcting unit 32, and a modulation analyzing unit 34.

The data acquiring unit 12 receives a signal to be received modulated by a modulation method of different types such as W-CDMA (Wide band Code Division Multiple Access) and QPSK (Quadrature Phase Shift Keying), and outputs a received signal.

The clock delay estimating and correcting unit 14 uses Clock Delay method to estimate a symbol point of the received signal, and simultaneously, uses the estimated symbol point to correct the symbol point of the received signal. As a result, the symbol point of the received signal is coarsely corrected. The corrected received signal (referred to as “clock delay corrected signal”) is output to the demodulating unit 16 and the symbol point finely estimating unit 20.

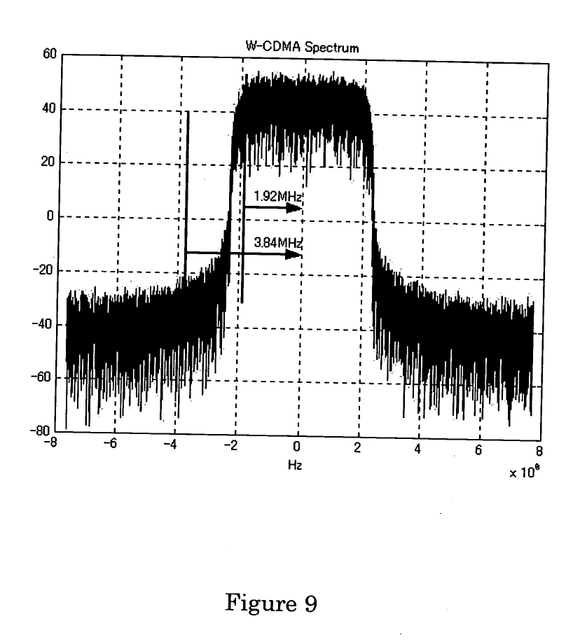

The description here is provided for an example of applying the Clock Delay method to W-CDMA (Wide band Code Division Multiple Access). First, FIG. 9 shows a spectrum of a received signal of the W-CDMA. The received signal in the W-CDMA hardly includes a symbol rate (3.84 Msps) component. Thus, it is difficult to extract the clock directly from the symbol rate (3.84 Msps) component. However, a large quantity of a 1.92 MHz component is included in the received signal.

Thus, a signal of 3.84 MHz is generated by multiplication using the component of half a frequency (1.92 Msps=1.92 MHz) of the symbol rate (3.84 Msps). Then, the symbol point is estimated by obtaining the phase of the generated signal of 3.84 MHz. The phase of the generated signal of 3.84 MHz is obtained according to expression (1).

$$arctan \{ \frac{{\sum }_{k = 0}^{n} [ {I}_{k}^{2} + {Q}_{k}^{2} ] \cdot sin [ 2 π {f}_{symbol} \cdot \frac{k}{{f}_{sample}} ]}{{\sum }_{k = 0}^{n} [ {I}_{k}^{2} + {Q}_{k}^{2} ] \cdot cos [ 2 π {f}_{symbol} \cdot \frac{k}{{f}_{sample}} ]} \} \qquad ( 1 )$$

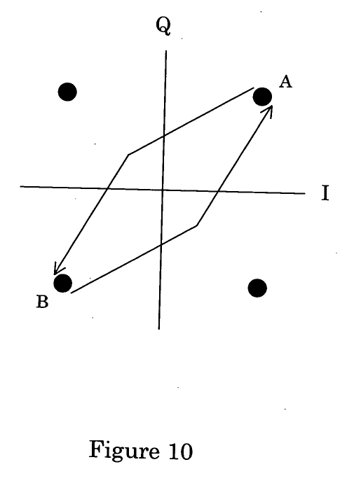

In expression (1), fsymbol represents the symbol rate (3.84 Msps), and fsample represents the sample rate. When expression (1) is used to obtain the phase, a transition of the symbol points shown in FIG. 10 is assumed. Namely, it is assumed that the transition moving through point A→point B→point A→ . . . occurs in every symbol period (1/3.84 MHz) for generating the 1.92 MHz component.

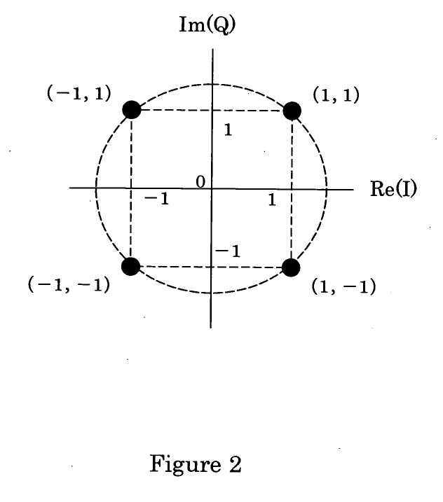

The demodulating unit 16 demodulates the clock delay corrected signal, and outputs a demodulated result to the reference signal generating unit 18. The reference signal generating unit 18 receives the demodulated result, and generates a reference signal which is a reference of the modulation. For example, the real part and the imaginary part of the reference signal in QPSK modulation are represented as (real part, imaginary part)=(1, 1), (−1, −1), (1, −1), and (−1, 1) as shown in FIG. 2.

The symbol point finely estimating unit (symbol point estimating apparatus) 20 estimates the symbol point of the modulation based on the clock delay corrected signal and the reference signal. Note that it is preferable to use clock delay corrected signal when the symbol point of the modulation is estimated. However, the symbol point finely estimating unit (symbol point estimating apparatus) 20 can estimate the symbol point of the modulation based on the received signal and the reference signal when the precision with respect to the symbol point is favorable in the received signal. Namely, the symbol point finely estimating unit (symbol point estimating apparatus) 20 estimates the symbol point of the modulation based on a measured signal based on the received signal, and the reference signal. The measured signal based on the received signal may be the clock delay corrected signal which is a coarsely corrected received signal in terms of the symbol point, or the received signal itself. It is only necessary that the measured signal is based on the received signal.

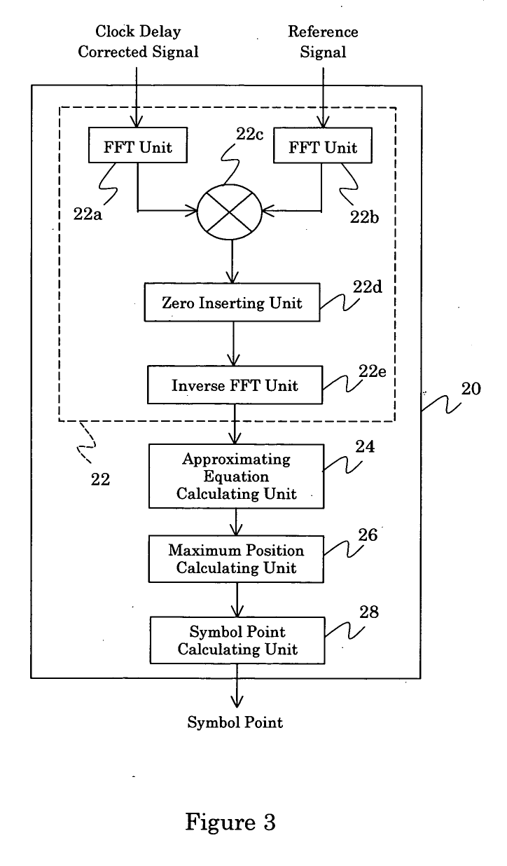

FIG. 3 shows the internal constitution of the symbol point finely estimating unit 20. The symbol point finely estimating unit 20 includes signal correlation calculating means 22, an approximating equation calculating unit 24, a maximum position calculating unit 26, and a symbol point calculating unit 28.

The signal correlation calculating means-22 calculates the correlation between the clock delay corrected signal (a type of the measured signal) and the reference signal. The correlation is represented by expression (2).

$$y ( t ) = {\vert {\sum }_{τ = 1}^{N} {s}_{τ} \cdot {r}_{τ - t}^{*} \vert}^{2} \qquad ( 2 )$$

Note that s_{τ} is the clock delay corrected signal, and r_{τ-t} is the reference signal. In addition, * represents a conjugate complex number. As expression (2) shows, the correlation is represented as convolution in the time domain.

Though it is possible to calculate the correlation between the clock delay corrected signal and the reference signal directly in the time domain, the multiplication and addition take time as is observed from the expression (2). Thus, in the first embodiment, transforming to and inverse-transforming from the frequency domain are conducted.

The signal correlation calculating means 22 includes FFT (Fast Fourier Transfer) units 22a (measured signal transforming means) and 22b (reference signal transforming means), a multiplying unit 22c, a zero inserting unit (data inserting means) 22d, and an inverse FFT unit (signal inverse transforming means) 22e.

The FFT unit (measured signal transforming means) 22a applies FFT to the clock delay corrected signal. The clock delay corrected signal s_{τ} is transformed to a signal S_{f} associated with the frequency. This signal S_{f} is referred to as a frequency-associated measured signal. The FFT unit (reference signal transforming means) 22b applies FFT to the reference signal. The reference signal r_{τ-t}* is transformed to a signal R_{f} associated with the frequency. This signal R_{f} is referred to as a frequency-associated reference signal.

The multiplying unit 22c multiples the frequency-associated measured signal S_{f} and the frequency-associated reference signal R_{f} by each other. When the result of the multiplication is indicated by Y_{f}, Y_{f} is represented by expression (3).
Y_{f}=S_{f}*R_{f} (3)

The correlation is represented as convolution in the time domain, and the convolution is represented as multiplication in the frequency domain. Thus, Y_{f} is the correlation in the frequency domain. It is possible to represent the correlation in the time domain by transforming Y_{f} into a signal associated with time by the inverse FFT unit (signal inverse transforming means) 22e. However, since this method provides correlation values only at the data interval, the zero inserting unit (data inserting means) 22d inserts data of a predetermined size such as zeros into Y_{f}, and the inverse FFT unit (signal inverse transforming means) 22e applies inverse FFT to the result. When zeros are inserted into Y_{f}, the range from which the data are obtained appears to extend in the frequency domain. Also, since time=1/frequency, the range in the time domain narrows as the range in the frequency domain extends. Thus, the position of the symbol point is estimated with respect to the individual narrower time ranges.

The Y_{f} to which the zero inserting unit (data inserting means) 22d inserted zeros is represented as (Y_{f}, 0_{f+xn}). Namely, a large number of zeros are inserted following Y_{f}. The inverse FFT unit (signal inverse transforming means) 22e applies inverse FFT to (Y_{f}, 0_{f+xn}). Consequently, (Y_{f}, 0_{f+xn}) is transformed back to a signal yₜ associated with time.

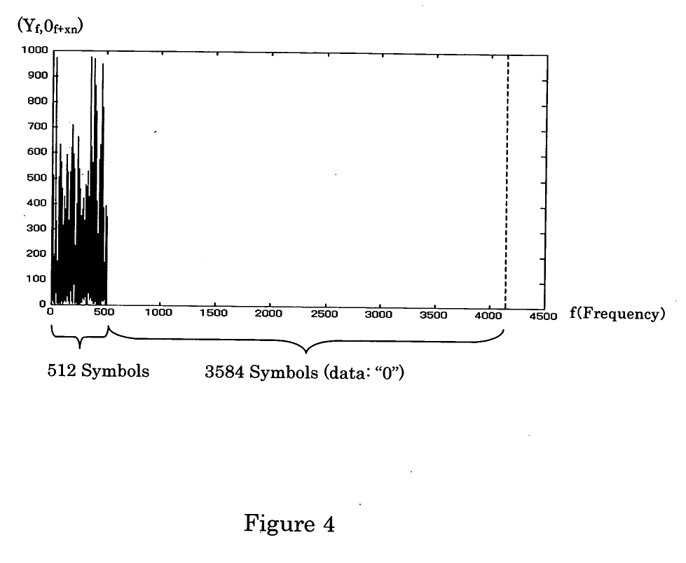

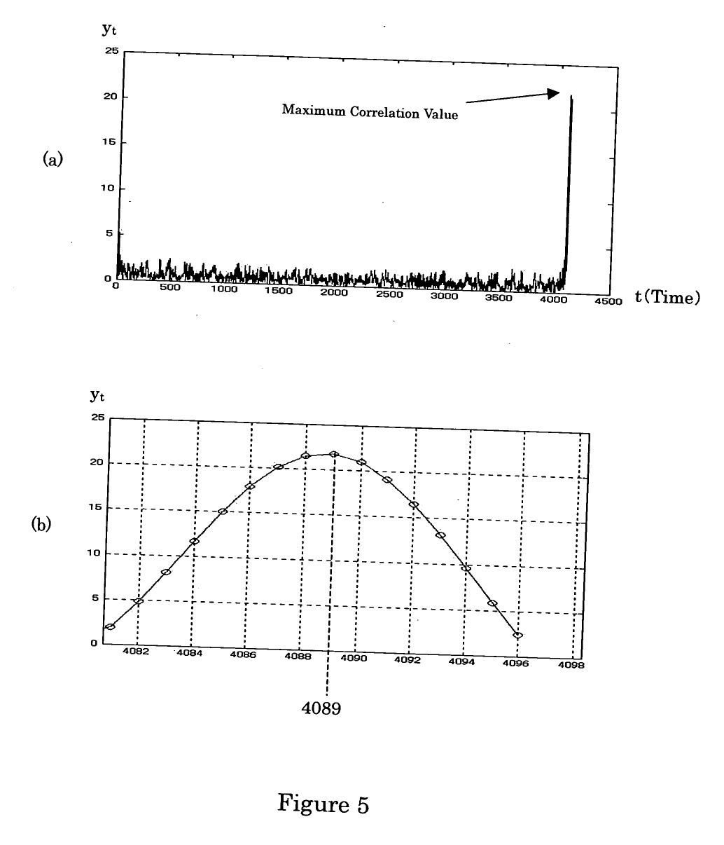

FIG. 4 shows an example of (Y_{f}, 0_{f+xn}), which is Y_{f} to which the zero inserting unit 22d inserted zeros, and FIG. 5 shows an example of the signal yₜ associated with time, which is the signal obtained by inverse FFT applied by the inverse FFT unit 22e.

In the example shown in FIG. 4, Y_{f} is a data obtained by calculating a correlation using 512 symbols, and 3584 of zeros are inserted following Y_{f}. As a result, the range of frequency across which data are acquired appears to extend from 512 to 512+3584=4096(=512×8), which is eight times of 512. Thus, the intervals between symbols are interpolated, and the position of the symbol point is estimated with eight times of detail.

In the example shown in FIG. 5(a), since inverse FFT is applied to (Y_{f}, 0_{f+xn}), and the correlation value takes the maximum at a position after 4000, it is observed that this is the position of the symbol point. FIG. 5(b) is an enlarged view of a neighborhood of the position where the correlation value takes the maximum in FIG. 5(a). According to FIG. 5(b), the position of the symbol point is in a vicinity of a point 4089. This result is also obtained by using the Clock Delay method to estimate the symbol point of the received signal. However, the position of the symbol point is slightly displaced from the position of the point 4089. This displacement is caused by an error of the Clock Delay method.

Returning to FIG. 3, the approximating equation calculating unit 24 calculates an approximating equation for approximating the calculated result provided from the signal correlation calculating means 22 (such a result as that shown in FIG. 5(b)). The method of least squares is used for calculating the approximating equation, for example. Since there certainly exist different approximating methods in addition to the method of the least squares, the method for calculating the approximating equation is not limited to the method of the least squares.

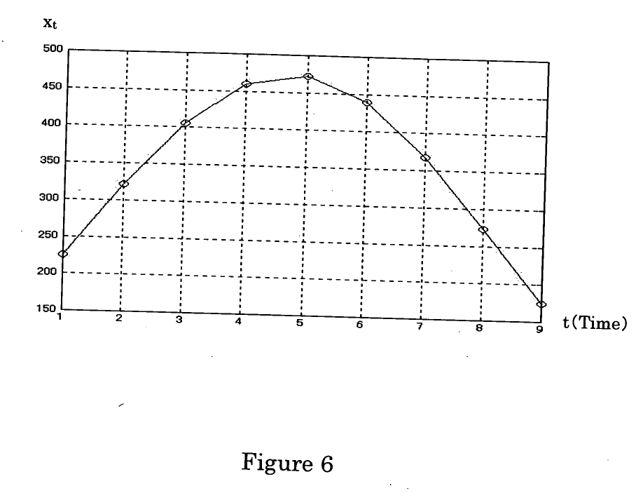

Description is provided for a case of calculating the approximating equation for the example shown in FIG. 5(b). Since it is apparent that the correlation value takes the maximum in a range from a point 4085 to a point 4093, the approximating equation is calculated in the range from the point 4085 to the point 4093. Note that it is assumed that zₜ=y₄₀₈₅₋₄₀₉₃ (t=1-9). Since the signal yₜ associated with time represents a complex number, and thus, it is difficult to obtain the maximum value, the signal is converted into the absolute value xₜ. Note that xₜ=Real (zₜ)\hat{ }2+Imag(zₜ)\hat{ }2. Real (zₜ) is the real part of zₜ, and Imag (zₜ) is the imaginary part of zₜ. xₜ is shown in FIG. 6. The approximating equation calculating unit 24 uses the method of least squares to approximate xₜ, and obtains the approximating equation as a second order equation. Since the method of least squares is widely known, description is not provided. It is assumed that the approximating equation is xₜ=at²+bt+c, which is a second order equation.

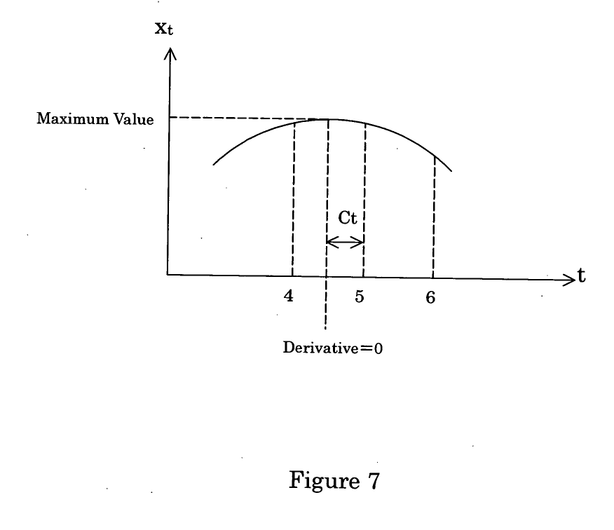

Returning to FIG. 3, the maximum position calculating unit 26 calculates a position where the approximating equation takes the maximum value based on the approximating equation. For that purpose, it is only necessary to differentiate the approximating equation, and to obtain a position where the derivative takes 0. For example, when the approximating equation calculating unit 24 calculates the approximating equation as xₜ=at²+bt+c, the equation is differentiated with respect to (t), and 2 at +b is obtained. The position where the derivative takes 0 is represented as t=−b/2a. Then, the maximum position calculating unit 26 obtains a difference Ct between the position where the derivative takes 0, and the symbol point of the received signal estimated by the Clock Delay method. The difference Ct is described referring to FIG. 7. FIG. 7 is an enlarged view of a neighborhood of t=5 (originally t=4089) in FIG. 6. Ct is a position error of the symbol point of the received signal estimated by the Clock Delay method as shown in FIG. 7.

Returning to FIG. 3, the symbol point calculating unit 28 calculates the position of the symbol point based on the position calculated by the maximum point calculating unit 26. Namely, the symbol point calculating unit 28 adds the error Ct calculated by the maximum position calculating unit 26 to the position of the symbol point of the received signal estimated by the Clock Delay method, thereby obtaining a precise position Delta_t of the symbol point.

Returning to FIG. 1, the symbol point correcting unit 32 corrects the received signal (a type of the measured signal) based on the symbol point estimated by the symbol point finely estimating unit 20. Note that the symbol point correcting unit 32 may corrects the clock delay corrected signal (a type of the measured signal). Namely, the symbol point correcting unit 32 corrects the measured signal. The measured signal based on the received signal may be a clock delay corrected signal which is a coarsely corrected received signal in terms of the symbol point, or the received signal itself. It is only necessary that the measured signal is based on the received signal.

The modulation analyzing unit 34 uses the reference signal generated by the reference signal generating unit 18, and the clock delay corrected signal (measured signal) corrected by the symbol point correcting unit 32 to analyze the modulation.

The following section describes the operation of the first embodiment.

First, referring to FIG. 1, the signal to be received modulated by a modulation method of different types such as W-CDMA and QPSK is received by the data acquiring unit 12, and the received signal is output from the data acquiring unit 12.

The received signal is output to the symbol point correcting unit 32. The received signal is also output as the clock delay corrected signal from the clock delay estimating and correcting unit 14 after the symbol point of the received signal is coarsely corrected by the clock delay estimating and correcting unit 14.

The clock delay corrected signal is input to the demodulating unit 16 and the symbol point finely estimating unit (symbol point estimating apparatus) 20. The demodulating unit 16 demodulates the clock delay corrected signal. The reference signal generating unit 18 receives the clock delay corrected signal which has been demodulated, and then, generates the reference signal, and the reference signal is output to the symbol point finely estimating unit 20 and the modulation analyzing unit 34.

The symbol point finely estimating unit 20 receives the clock delay corrected signal and the reference signal, and then, estimates the position of the symbol point. Note that the received signal may be used in place of the clock delay corrected signal. Namely, the symbol point finely estimating unit 20 receives the reference signal and the measured signal based on the received signal, and then, estimates the position of the symbol point.

Referring to FIG. 3, the correlation between the clock delay corrected signal and the reference signal is calculated by the signal correlation calculating means 22. Then, the approximating equation calculating unit 24 approximates the neighborhood of the maximum value of the calculated correlation using the approximating equation. Based on the approximating equation, the maximum position calculating unit 26 calculates the position where the correlation takes the maximum value, and the symbol point calculating unit 28 calculates the position of the symbol point. Consequently, the position of the symbol point is estimated.

Note that the signal correlation calculating means 22 calculates the correlation as described below. First, the clock delay corrected signal and the reference signal are transformed respectively by the FFT unit 22a and the FFT unit 22b into the signals associated with the frequency domain, and are multiplied by each other by the multiplying unit 22c. After the zero inserting unit 22d inserts zeros into the data Yf obtained consequently, the data is transformed back to the signal associated with the time domain by the inverse FFT unit 22e.

Returning to FIG. 1, the estimated position of the symbol point is output to the symbol point correcting unit 32.

The symbol point correcting unit 32 receives the estimated position of the symbol point and the received signal (any type of the measured signal such as the clock delay corrected signal), then, corrects the received signal (a type of the measured signal), and outputs the resultant signal to the modulation analyzing unit 34 after.

Finally, the modulation analyzing unit 34 uses the reference signal and the precisely corrected measured signal to analyze the modulation.

With the first embodiment, the signal correlation calculating means 22 in the symbol point finely estimating unit 20 calculates the correlation between the measured signal (such as the clock delay corrected signal and the received signal) and the reference signal, and then, the symbol point calculating unit 28 calculates the position of the symbol point from this calculated result. Thus, the symbol point is estimated precisely.

It takes time for the multiplication and addition when the correlation is obtained directly based on the time domain signal s_{τ} of the measured signal and the time domain signal r_{τ-t} of the reference signal (see expression (2)). However, with the first embodiment, the correlation between the measured signal and the reference signal is obtained such that FFT units 22a and 22b transform the measured signal and the reference signal to the signals associated with frequency, the multiplying unit 22c multiplies these signals, and the inverse FFT unit 22e transforms the result back to the signal associated with time. Thus, the time required for calculating the correlation can be reduced.

Additionally, the zero inserting unit 22d inserts a data of a predetermined size such as zeros into the result of the multiplication provided from the multiplying unit 22c, and the inverse FFT unit 22e applies the inverse FFT to the inserted result, the range of the frequency across which the data are acquired appears to extend. As a result, since time=1/frequency, and the range in the time domain narrows as the range in the frequency domain extends, the position of the symbol point can be estimated with respect to the individual narrower time range.

Further, the approximating equation calculating unit 24 calculates the approximating equation approximating the result calculated by the signal correlation calculating means 22, and the maximum position calculating unit 26 calculates the position where the approximating equation takes the maximum value based on the approximating equation. As a result, it is possible to obtain the error in estimating the position of the symbol point smaller than the interval of the symbol points, which is caused by the clock delay estimating and correcting unit 14.

In addition, since the measured signal is corrected by the symbol point correcting unit 32 based on the symbol point precisely estimated by the symbol point finely estimating unit 20, it is possible to precisely correct the measured signal. Then, since the modulation analyzing unit 34 uses the reference signal and the precisely corrected measured signal for the modulation analysis, the modulation is analyzed precisely.

The following section describes comparison between the estimated symbol point by the symbol point finely estimating unit 20 according to the first embodiment, and the estimated symbol point by the conventional Clock Delay method.

Table 1 shows the estimation only by the Clock Delay method and the estimation by the symbol point finely estimating unit 20 when the symbol point is at −0.25 symbol time for a W-CDMA signal.

TABLE 1

| | Clock Delay method | | | |
|---|---|---|---|---|
| | (conventional) | | First Embodiment | |
| | Delay | EVM | Delay | EVM |
| | (Symbol time) | (% rms) | (Symbol time) | (rms) |
| Minimum | −0.2490 | 0.1776 | −0.2499 | 0.0262 |
| Maximum | −0.2512 | 0.0122 | −0.2510 | 0.0121 |
| Range | 0.0022 | 0.1654 | 0.0002 | 0.0141 |

It is observed that, with the symbol point finely estimating unit 20, the error of the symbol point is corrected down to about 1/10. Consequently, it is observed that the modulation accuracy is improved from 0.177% rms to 0.0262% rms.

Further, Table 2 shows the modulation accuracy evaluated for a signal whose frequency characteristic around ±1.92 MHz is degraded for misleading the evaluation by the Clock Delay method for a W-CDMA signal.

TABLE 2

| Clock Delay method (conventional) | | First Embodiment | |
|---|---|---|---|
| Delay | | Delay | |
| (Symbol time) | EVM (% rms) | (Symbol time) | EVM (rms) |
| −0.004315 | 8.1154 | −0.0591 | 3.6937 |

Since a signal whose chip point is displaced in the Clock Delay method is generated, the modulation accuracy degrades more than the case shown in Table 1 in both of the methods. However, the estimation of the signal which appears to exceeding 8% rms by the Clock Delay method can be reduced to about 3.7% rms by the symbol point finely estimating unit 20.

In this way, the estimation of the symbol point by the symbol point finely estimating unit 20 provides extremely advantageous effect compared with the prior art.

Second Embodiment

In a second embodiment, though the constitution of the symbol point finely estimating unit (symbol point estimating apparatus) 20 is similar to that in the first embodiment, it differs from the first embodiment in that the signal corrected by a symbol point correcting unit 32 is the reference signal.

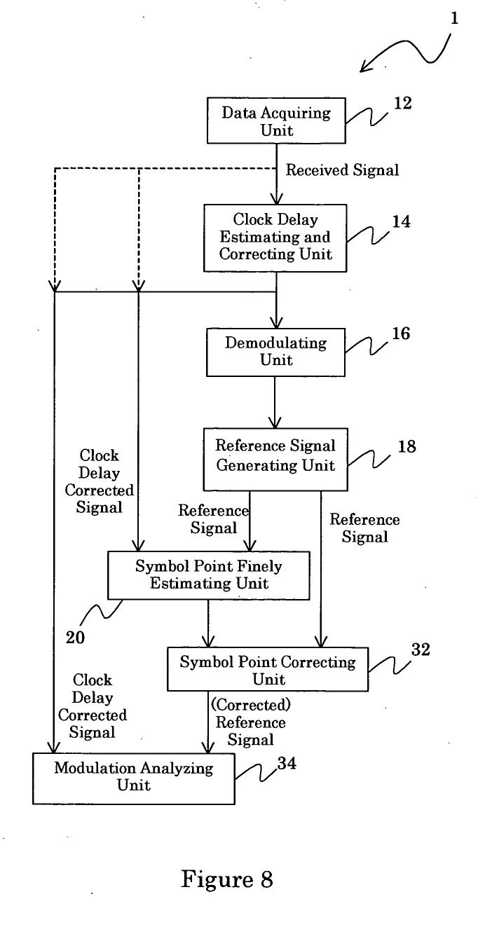

FIG. 8 is a block diagram showing the constitution of a modulation analyzing apparatus 1 according to the second embodiment of the present invention. Parts similar to those in the first embodiment are assigned the same reference numbers, and description is not provided for them.

The modulation analyzing apparatus 1 according to the second embodiment of the present invention includes a data acquiring unit 12, a clock delay estimating and correcting unit 14, a demodulating unit 16, a reference signal generating unit 18, a symbol point finely estimating unit (symbol point estimating apparatus) 20, a symbol point correcting unit 32, and a modulation analyzing unit 34.

The data acquiring unit 12, the clock delay estimating and correcting unit 14, the demodulating unit 16, the reference signal generating unit 18, and the symbol point finely estimating unit (symbol point estimating apparatus) 20 are similar to those in the first embodiment, and description is not provided for them.

Note that the clock delay estimating and correcting unit 14 outputs a clock delay corrected signal to the modulation analyzing unit 34 in addition to the demodulating unit 16 and the symbol point finely estimating unit 20. The reference signal generating unit 18 outputs a reference signal to the symbol point finely estimating unit 20 and the symbol point correcting unit 32.

The symbol point correcting unit 32 corrects the reference signal based on the symbol point estimated by the symbol point finely estimating unit 20.

The modulation analyzing unit 34 uses the reference signal corrected by the symbol point correcting unit 32, and the clock delay corrected signal (a type of the measured signal) to analyze the modulation. Note that the modulation analyzing unit 34 may correct the received signal (a type of the measured signal). Namely, the modulation analyzing unit 34 uses the reference signal and the measured signal to analyze the modulation. The measured signal based on the received signal may be a clock delay corrected signal which is a coarsely corrected received signal in terms of the symbol point, or the received signal itself. It is only necessary that the measured signal is based on the received signal.

The following section describes the operation of the second embodiment.

First, referring to FIG. 8, a signal to be received modulated by a modulation method of different types such as W-CDMA and QPSK is received by the data acquiring unit 12, and the received signal is output from the data acquiring unit 12.

The received signal is output as the clock delay corrected signal from the clock delay estimating and correcting unit 14 after the symbol point of the received signal is coarsely corrected by the clock delay estimating and correcting unit 14.

The clock delay corrected signal is input to the demodulating unit 16, the symbol point finely estimating unit (symbol point estimating apparatus) 20, and the modulation analyzing unit 34. The demodulating unit 16 demodulates the clock delay corrected signal. The reference signal generating unit 18 receives the clock delay corrected signal which has been demodulated, and then, generates the reference signal, and the reference signal is output to the symbol point finely estimating unit 20 and the symbol point correcting unit 32.

The symbol point finely estimating unit 20 receives the clock delay corrected signal and the reference signal, and then, estimates the position of the symbol point. Note that the received signal may be used in place of the clock delay corrected signal. Namely, the symbol point finely estimating unit 20 receives the reference signal and the measured signal based on the received signal, and then, estimates the position of the symbol point.

Referring to FIG. 3, the correlation between the clock delay corrected signal and the reference signal is calculated by a signal correlation calculating means 22. Then, an approximating equation calculating unit 24 approximates a neighborhood of the maximum value of the calculated correlation using an approximating equation. Based on the approximating equation, a maximum position calculating unit 26 calculates the position where the correlation takes the maximum value, and a symbol point calculating unit 28 calculates the position of the symbol point. Consequently, the position of the symbol point is estimated.

Note that the signal correlation calculating means 22 calculates the correlation as described below. First, the clock delay corrected signal and the reference signal are transformed respectively by an FFT unit 22a and an FFT unit 22b into the signals associated with the frequency domain, and are multiplied by each other by a multiplying unit 22c. After a zero inserting unit 22d inserts zeros into data Y_{f} obtained consequently, the data is transformed back to a signal associated with the time domain by an inverse FFT unit 22e.

Returning to FIG. 8, the estimated position of the symbol point is output to the symbol point correcting unit 32.

The symbol point correcting unit 32 receives the estimated position of the symbol point and the reference signal, then, corrects the reference signal, and outputs the signal to the modulation analyzing unit 34.

Finally, the modulation analyzing unit 34 uses the clock delay corrected signal (a type of the measured signal) and the precisely corrected reference signal to analyze the modulation.

The second embodiment provides a similar effect as the first embodiment. Simultaneously, since the reference signal is corrected by the symbol point correcting unit 32 based on the symbol point precisely estimated by the symbol point finely estimating unit 20, it is possible to precisely correct the reference signal. Further since the modulation analyzing unit 34 uses the measured signal and the precisely corrected reference signal for the modulation analysis, the modulation is analyzed precisely. At this moment, since the reference signal is a signal based on individual symbols, the quantity of the calculation can be reduced in the symbol point correcting unit 32, and the calculation is accelerated.

Additionally, the embodiments described above may be realized in the following way. A computer includes a CPU, a hard disk, and a media (such as a floppy disk and a CD-ROM) reading apparatus, the media reading apparatus reads a medium recording a program realizing the individual parts described above (such as the symbol point finely estimating unit 20), and the program is installed on the hard disk. The functions described above are also realized in this way.

With the present invention, the signal correlation calculating means calculates the correlation between the measured signal and the reference signal, and then, the symbol point calculating means calculates the position of the symbol point from the result of this correlation calculation. Thus, the symbol point is estimated precisely.

Simultaneously, since the measured signal is corrected by the symbol point correcting means based on the symbol point precisely estimated by the symbol point estimating unit, the measured signal can be precisely corrected. Then, since the modulation analyzing means uses the reference signal and the precisely corrected measured signal to analyze the modulation, the modulation is analyzed precisely.

Alternately, since the reference signal is corrected by the symbol point correcting means based on the symbol point precisely estimated by the symbol point estimating unit, the reference signal is precisely corrected. Then, since the modulation analyzing means uses the measured signal and the precisely corrected reference signal for analyzing the modulation, the modulation is analyzed precisely. Simultaneously, since the reference signal is a signal based on individual symbols, the quantity of the calculation can be reduced in the symbol point correcting means, and the calculation is accelerated.

1. A symbol point estimating apparatus for estimating a symbol point of modulation based on a measured signal based on a received signal to which said modulation is applied, and a reference signal serving as a reference of said modulation, the apparatus comprising:
a signal correlation calculating element for calculating correlation between said measured signal and said reference signal; and
a symbol point calculating element for calculating a symbol point from a calculated result from said signal correlation calculating element.

2. The symbol point estimating apparatus according to claim 1, wherein said measured signal is a signal generated by correcting said symbol point of said received signal.

3. The symbol point estimating apparatus according to claim 1 or 2 claim 1, wherein said signal correlation calculating element comprises:
a measured signal transforming element for transforming said measured signal to a frequency-associated measured signal;
a reference signal transforming element for transforming said reference signal to a frequency-associated reference signal;
a multiplying element for multiplying said frequency-associated measured signal and said frequency-associated reference signal by each other; and
a signal inverse-transforming element for transforming an output from said multiplying element to a signal associated with time as a calculated result from said signal correlation calculating element.

4. A symbol point estimating apparatus according to claim 3, wherein said signal correlation calculating element further comprises a data inserting element for inserting data of a predetermined size to the output from said multiplying element in order to supply the output for said signal inverse-transforming element.

5. The symbol point estimating apparatus according to claim 1, further comprising:
an approximating equation calculating element for calculating an approximating equation approximating at least a part of the calculated result by said signal correlation calculating element; and
a maximum position calculating element for calculating a position where said approximating equation takes the maximum value based on said approximating equation, and
wherein said symbol point calculating element calculates the position of said symbol point based on the position calculated by said maximum position calculating element.

6. A modulation analyzing apparatus for analyzing modulation based on a measured signal based on a received signal to which said modulation is applied, and a reference signal serving as a reference of said modulation, the modulation analyzing apparatus comprising:
the symbol point estimating apparatus according to claim 1;
a symbol point correcting element for correcting said measured signal based on said symbol point estimated by said symbol point estimating apparatus, and
a modulation analyzing element for using said reference signal and said corrected measured signal to analyze modulation.

7. A modulation analyzing apparatus for analyzing modulation based on a measured signal based on a received signal to which said modulation is applied, and a reference signal serving as a reference of said modulation, the modulation analyzing apparatus comprising:
the symbol point estimating apparatus according to claim 1;
a symbol point correcting element for correcting said reference signal based on said symbol point estimated by said symbol point estimating apparatus, and
a modulation analyzing element for using said measured signal and said corrected reference signal to analyze modulation.

8. A symbol point estimating method for estimating a symbol point of modulation based on a measured signal based on a received signal to which said modulation is applied, and a reference signal serving as a reference of said modulation, the method comprising:
a signal correlation calculating step for calculating correlation between said measured signal and said reference signal; and
a symbol point calculating step for calculating a symbol point from a calculated result from said signal correlation calculating step.

9. A symbol point estimating method for estimating a symbol point of modulation based on a measured signal based on a received signal to which said modulation is applied, and a reference signal serving as a reference of said modulation, the method comprising:
a signal correlation calculating step for calculating correlation between said measured signal and said reference signal; and
a symbol point calculating step for calculating a symbol point from a calculated result from said signal correlation calculating step,
wherein said signal correlation calculating step comprises
a measured signal transforming step for transforming said measured signal to a frequency-associated measured signal;
a reference signal transforming step for transforming said reference signal to a frequency-associated reference signal;
a multiplying step for multiplying said frequency-associated measured signal and said frequency-associated reference signal by each other;
a signal inverse-transforming step for transforming an output from said multiplying step to a signal associated with time as a calculated result from said signal correlation calculating step; and
a data inserting step for inserting data of a predetermined size to the output from said multiplying step in order to supply the output for said signal inverse-transforming step.

10. A program of instructions for execution by the computer to perform a symbol point estimating process for estimating a symbol point of modulation based on a measured signal based on a received signal to which said modulation is applied, and a reference signal serving as a reference of said modulation, the process comprising:
a signal correlation calculating processing for calculating correlation between said measured signal and said reference signal; and
a symbol point calculating processing for calculating a symbol point from a calculated result from said signal correlation calculating processing.

11. A computer-readable medium having a program of instructions for execution by the computer to perform a symbol point estimating process for estimating a symbol point of modulation based on a measured signal based on a received signal to which said modulation is applied, and a reference signal serving as a reference of said modulation, the process comprising:
a signal correlation calculating processing for calculating correlation between said measured signal and said reference signal; and
a symbol point calculating processing for calculating a symbol point from a calculated result from said signal correlation calculating processing.
